(19) United States
(12) Patent Application Publication
(10) Pub. No.: US 2025/0378522 A1
(43) Pub. Date: Dec. 11, 2025

(54) Uninitialized Access Protection of a Register

(71) Applicant: Imagination Technologies Limited, Kings Langley (GB)

(72) Inventor: Mark Sheppard, Hertfordshire (GB)

(21) Appl. No.: 19/174,276

(22) Filed: Apr. 9, 2025

(30) Foreign Application Priority Data
Apr. 9, 2024 (GB) 2405052.8

(51) Int. Cl. G06T 1/20; G06T 1/60

(52) U.S. Cl. CPC G06T 1/20; G06T 1/60

(57) ABSTRACT

A method of preventing unauthorized access to uninitialized memory. Registers are grouped into blocks, each of which has a corresponding validity bit. When data is written to a block of memory the validity bit is set to valid. A read function reads both the register data and the validity bit but if the validity bit is set to invalid dummy values are output. Once a program is complete, or before a fresh program the validity bits are reset to invalid.

### CROSS-REFERENCE TO RELATED APPLICATIONS AND CLAIM OF PRIORITY

This application claims foreign priority under 35 U.S.C. 119 from United Kingdom patent application No. 2405052.8 filed on 9 Apr. 2024, the contents of which are incorporated by reference herein in their entirety.

### TECHNICAL FIELD

The present disclosure relates to graphics processing systems, in particular those implementing shading programs.

### BACKGROUND

Graphics processing systems are typically configured to receive graphics data, e.g. from an application running on a computer system, and to render the graphics data to provide a rendering output. For example, the graphics data provided to a graphics processing system may describe geometry within a three dimensional (3D) scene to be rendered, and the rendering output may be a rendered image of the scene.

A shader program is used in the rendering of a scene and, during processing, these store data in register files. When rendering an image by rasterisation, graphics data items are sampled to determine coverage, e.g., to determine which pixels of a tile are covered by a triangular primitive. A fragment may be generated for each sample position, and fragments are shaded (using shader programs, which may also be termed ‘shaders’ or ‘shading programs’) to determine the colours of the pixels of the image. Graphics shader programs may also be used at other stages in the graphics pipeline (e.g. vertex shaders, geometry shaders or tessellation shaders), or may be used in other types of graphics rendering (such as ray tracing shaders), and other types of shader programs (such as compute shaders) may be used to perform other types of task on a GPU. Such shader programs may produce a direct output (such as a shaded fragment), but may also produce outputs more indirectly (such as by calling other shader programs).

Resettable memory occupies a larger area so register files used by shader programs are usually non-resettable in order to save area. When a graphics processing unit (GPU) finishes executing a shader program the data most recently written remains in the register. Consequently, the most recent data from a previous shader program is visible to a subsequent shader program whose registers are allocated the same physical memory. This creates a security risk as the data could be read by the subsequent shader program.

One possible solution is to overwrite all the registers before a shader program begins but this would require the use of an additional program specifically to overwrite. The registers could be overwritten with zeros, ones, a pattern of ones and zeros or even with random data. Furthermore, this is time consuming and may waste power by overwriting registers that are not read by the subsequent shader program

An alternative solution is to use resettable memory but this occupies significantly more area and is therefore undesirable. Furthermore, resettable RAMs have a single reset line. Thus, overlapping shader programs cannot run because all the registers would be reset. Furthermore, the reset may take multiple cycles which adds processing latency.

One proposal has been to use an independent validity bit for each register which is independently accessible. This allows the validity of each register to be monitored independently. However, this requires a very large number of validity bits, incurring a large area penalty.

There is therefore a need to prevent access to previously written registers by subsequent programs in a time and memory efficient way.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Within a graphical processing system a plurality of different shading programs may be executed by a single processor. The different shading programs reuse the same memory area and if the memory is not reset a subsequent shading program may access the earlier written data. Resetting all the data is time consuming and is also not possible if there is another shader program running in parallel. The present invention provides a method of preventing the unauthorised access of data previously written in a register file. There is a method of reading data from a register memory, the register memory having a plurality of registers, each configured to store a value, and a plurality of validity bits, the plurality of registers being divided into a plurality of blocks, a block corresponding to one or more instances and a subset of the registers being allocated to each of those instances, each block having a corresponding validity bit, the method comprising:
reading at least one register in a first block;
reading the validity bit corresponding to the first block of registers;
if the validity bit is a first value outputting a predetermined value instead of each value from the corresponding registers;
if the validity bit is a second value outputting the at least one value read from the register.

Preferably, the at least one register in the block of registers is read in parallel. Optionally, the validity bit is read in parallel with the at least one register in the block.

Optionally, the method further comprises:
reading at least one register in a second block in parallel with reading the first block;
reading the validity bit corresponding to the second block of registers in parallel with reading the validity block corresponding to the first block of registers;
if the validity bit corresponding to the second block of registers is a first value outputting, in parallel with outputting either a predetermined value or a value from the first block, a predetermined value for each value from the corresponding register in the second block; and
if the validity bit is a second value outputting, in parallel with outputting either a predetermined value or a value from the first block, the at least one value read from the register in the second block.

According to another aspect of the invention there is provided a method of writing data to a register file, the register file having a plurality of registers and a plurality of validity bits, the plurality of registers being divided into a plurality of blocks, a block corresponding to one or more instances and a subset of the registers being allocated to each of those instances, each block having a corresponding validity bit, the register file having at least one write port, wherein the width of each block matches the width of a smallest write port of the at least one write ports, the method comprising:
reading the validity bit corresponding to the first block;
writing data to one or more registers in a first block;
if the validity bit is equal to a first value and if the quantity of data to be written is less than the number of registers in the first block writing a predetermined value to the remaining registers in the first block; and setting the validity bit corresponding to the first block of registers to a second value.

Optionally, each of the write ports has a width which is an integer multiple of the of the block width.

The method may involve determining that the validity bit is equal to the first value and determining that the quantity of data to be written is less than the number of registers in the first block and then writing the predetermined value to the remaining registers in the first block. If the validity bit is not equal to a first value and/or the quantity of data to be written is no less than the number of registers in the first block the remaining registers are not written to.

Preferably, the at least one register in the block of registers is written in parallel. Optionally, the validity bit is written in parallel with the at least one register in the block.

Optionally, the method further comprises:
writing data to each register in a second block in parallel with writing to the first block;
setting, in parallel with setting the validity bit corresponding to the first block of registers, the validity bit corresponding to the second block of registers to a second value.

Optionally, the writing a predetermined value to the remaining registers in the first block comprises expanding the write to cover all instances in the block and/or expanding the write to cover the entire subset of registers allocated to each of the instances.

The method of either aspect may be carried out by a GPU. The GPU may be a single instruction multiple data processor configured to process a number of elements in parallel and wherein the block has a breadth equal to the number of elements the GPU can process in parallel.

Optionally, the GPU has one or more write functions configured to write to a plurality of registers and wherein the block has a width no greater than the width of the write function configured to write to the fewest registers. Each write function is configured to write a number of registers that is an integer multiple of the number of registers of a block.

Each block may comprise 128 instances and 2 registers per instance.

The method may further comprise setting at least one of the validity bits to the first value. Optionally the method may comprise setting all the validity bits to the first value.

Preferably the register files are non-resettable memory and preferably the validity bits are resettable memory. Examples of resettable memory include resettable RAM or flip flops.

According to the invention there is provided a register file having a plurality of registers and a plurality of validity bits, the plurality of registers being divided into a plurality of blocks, a block corresponding to one or more instances and a subset of the registers being allocated to each of those instances, each block having a corresponding validity bit, the register file having at least one write port, wherein the width of each block matches the width of a smallest write port of the at least one write ports.

Optionally, each of the write ports has a width which is an integer multiple of the of the block width.

According to the invention there is provided a graphics processing system configured to perform methods described above.

The graphics processing system may be embodied in hardware on an integrated circuit.

There may be provided a method of manufacturing, at an integrated circuit manufacturing system, a graphics processing system. There may be provided an integrated circuit definition dataset that, when processed in an integrated circuit manufacturing system, configures the system to manufacture a graphics processing system. There may be provided a non-transitory computer readable storage medium having stored thereon a computer readable description of a graphics processing system that, when processed in an integrated circuit manufacturing system, causes the integrated circuit manufacturing system to manufacture an integrated circuit embodying a graphics processing system.

There may be provided an integrated circuit manufacturing system comprising: a non-transitory computer readable storage medium having stored thereon a computer readable description of the graphics processing system; a layout processing system configured to process the computer readable description so as to generate a circuit layout description of an integrated circuit embodying the graphics processing system; and an integrated circuit generation system configured to manufacture the graphics processing system according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1 shows a graphics processing system;

FIG. 2 depicts a memory according to the prior art;

FIG. 3 depicts a memory according to the invention;

FIG. 4 depicts a method according to the invention;

FIG. 5 depicts an alternative method according to the invention;

FIG. 6 depicts a method of executing a program;

FIG. 7 depicts an alternative method of executing a program;

FIG. 8 shows a computer system in which a graphics processing system is implemented;
and

FIG. 9 shows an integrated circuit manufacturing system for generating an integrated circuit embodying a graphics processing system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Shader programs store data on memory within a GPU and, when a first shader program is complete a second shader program may be executed. The second shader program may be allocated the same memory area as the first shader program. To avoid the second shader program being able to access data written to the memory by the first shader program it is necessary to reset the registers. However, this is time consuming and requires resettable memory which occupies a larger area, requires more power and has a higher latency. Alternatively separate validity bits (stored on resettable memory), indicating the validity of a corresponding register, could be used. However, in this scheme, one validity bit is required per register so a large number of validity bits are needed relative to the register file capacity.

The present disclosure presents a way to prevent unauthorized access of data without incurring a significant time or area penalty. The following description considers shading (and thus shader programs) in the context of a rendering phase in a deferred rendering system in particular, but it will be understood that this is by way of example and that other types of shader program can also benefit from the approaches described.

Embodiments will now be described by way of example only.

### General System

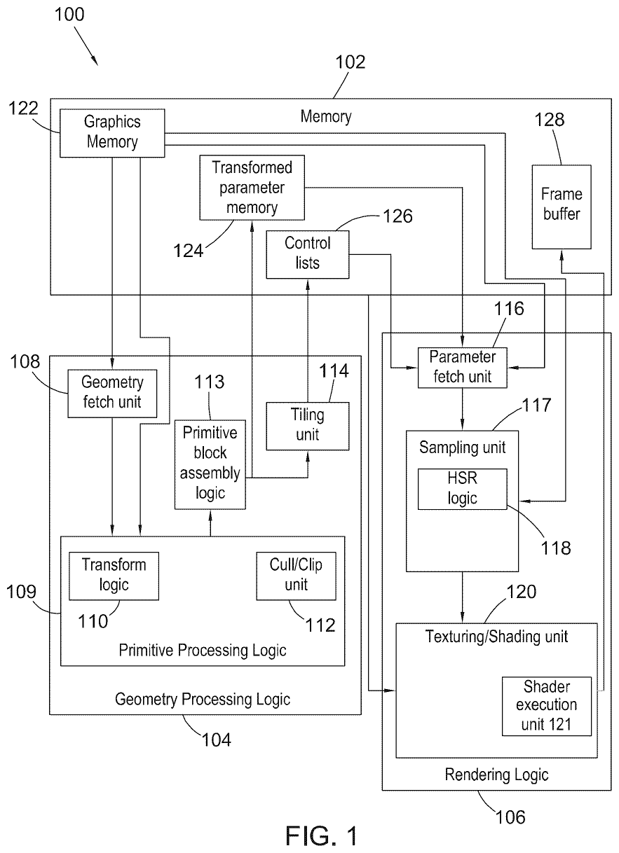

FIG. 1 shows an example graphics processing system 100. The example graphics processing system 100 is a tile-based graphics processing system. As mentioned above, a tile-based graphics processing system uses a rendering space which is subdivided into a plurality of tiles. The tiles are sections of the rendering space, and may have any suitable shape, but are typically rectangular (where the term “rectangular” includes square). The tile sections within a rendering space are conventionally the same shape and size.

The system 100 comprises a memory 102, geometry processing logic 104 and rendering logic 106. The geometry processing logic 104 and the rendering logic 106 may be implemented on a GPU and may share some processing resources, as is known in the art. The geometry processing logic 104 comprises a geometry fetch unit 108; primitive processing logic 109, which in turn comprises geometry transform logic 110 and a cull/clip unit 112; primitive block assembly logic 113; and a tiling unit 114. The rendering logic 106 comprises a parameter fetch unit 116; a sampling unit 117 comprising hidden surface removal (HSR) logic 118; and a texturing/shading unit 120 containing a shader execution unit 121. The example system 100 is a so-called “deferred rendering” system, because the texturing/shading is performed after the hidden surface removal. However, a tile-based system does not need to be a deferred rendering system, and although the present disclosure uses a tile-based deferred rendering system as an example, the ideas presented are also applicable to non-deferred (known as immediate mode) rendering systems or non-tile-based systems. The memory 102 may be implemented as one or more physical blocks of memory and includes a graphics memory 122; a transformed parameter memory 124; a control lists memory 126; and a frame buffer 128.

A GPU, on which a shader program is executed, is often a single instruction, multiple data processor meaning that it carries out the same instruction on a plurality of elements in parallel. In other words, there are multiple instances of the same program operating in parallel, each instance operating on a separate element. Many operations require the storage, albeit temporarily, of data. For each element, or instance, on which the processor is operating in parallel, one or more data fields may need to be stored. Thus, for each element, data must be stored in separate registers to those used to store data for other elements.

FIG. 2 depicts a memory according to the prior art. FIG. 2 is a logical view of the memory and the skilled person will appreciate that the physical view of the memory may differ from a logical view. As can be seen there are a plurality of registers 20, each of which may be used to store a value. A GPU may be considered to have a number of ‘slots’ for processing tasks, where a task may contain several instances running the same program (and, for completeness, it is noted that several slots may contain tasks running the same program for different sets of instances). The registers are grouped, 21, and allocated to a slot as that group. As such, the term ‘slot’ may be used to refer to capacity of the GPU to run a task, as well as the group of registers allocated to that task. The skilled person will understand the different usages from the context. There are generally several slots running concurrently within the shader execution unit, and each will be allocated a corresponding group of registers within the memory. As an example there may be 48 slots in a memory. Within a slot registers are allocated to instances, e.g. 111, 112, 113 . . . . Iin in the lower slot of FIG. 2, relating to a particular task, operation or calculation. In this example, the instances are depicted as horizontal rows within the slot. Within a SIMD GPU the number of instances in a slot is the number of number of instances that shader execution unit treats as a unit of scheduling and execution. In one example, a shader execution unit can process 128 instances in a slot but in other examples there may be more or fewer instances per slot. Thus, the SIMD GPU can read or write data to the registers of each instance in a slot in parallel. Each instance is allocated a plurality of registers. As an example, there may be 42 registers allocated per instance.

As an aside, the logical view of the instances in FIG. 2 echoes the physical arrangement of typical shader core register files which are “lane tied”. This means that each particular instance can only read and write its own set of registers. The read/write transactions are still processed for a whole slot at once, but each instance can only process its own set of data.

Read or write ports can read or write to each instance within a slot in parallel, but they can also read or write to a plurality of registers within each instance. As an example, a read port may read from 2 registers within each instance (and thus read from 2×128 registers in a slot of 128 instances) and would therefore be described as having a width of 2. Different read and write ports may have different widths and therefore read or write different numbers of registers.

Each slot is allocated, as a unit, when it becomes available. A plurality of instances is allocated to a slot when it becomes available. The GPU may execute different slots in an interleaved manner. As an example, the GPU may execute instances from a first slot during a first period, then execute the instances from a second slot, then execute instances from a third slot, then execute instances from the second slot. However, all instances from a particular slot are executed in parallel.

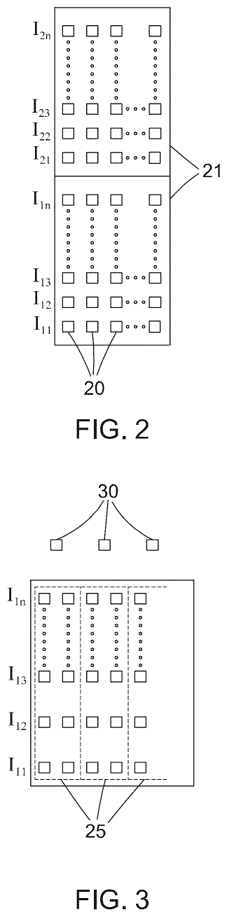

FIG. 3 depicts a logical view of a slot of memory according to the invention. The memory is similar to a slot of memory depicted in FIG. 2 and although only one slot is depicted there would be several. However, the memory is grouped into blocks 25. Each block 25 spans all the instances in the slot. In this example, each block has a width of 2 (registers) although different examples may have different block widths. However, in addition to the registers there are additionally validity bits 30 with one validity bit per corresponding block.

In the present example the validity bit is a single bit field with a first value indicating that the data in the corresponding block is invalid and a second value indicating that the data in the corresponding block is valid. In an example a “0” validity bit would indicate that the data in the corresponding block is invalid. A “1” validity bit would indicate that the data in the corresponding block is valid. The validity bits are stored on resettable memory (for example resettable flip flops) and can therefore easily be reset.

The validity bits are used to indicate the validity of the data in the corresponding block. By using resettable memory for the validity bits, each validity bit can easily be reset to a first value (e.g. 0) indicating that the corresponding block is invalid. The register memory is preferably non-resettable memory which occupies less area than the resettable memory. At the end of a program the validity bits corresponding to blocks used by the program can be set to the first value (e.g. 0) to indicate that the data is invalid. Alternatively the validity bits corresponding to blocks used by a new program can be reset at the beginning of a new program.

Whilst the additional presence of the validity bits incurs an area cost it is noted that, since one validity bit corresponds to an entire block of data registers that, they are few in comparison to the overall register file capacity. In other words, by using just one validity bit per block of registers the space required for validity data is considerably minimized. As an example, in a naïve scheme for a system with 128 instances per slot, 42 registers per instance, and 48 slots 258048 validity bits would be needed for one validity bit per register for each instance. This is because, although instances in a slot execute in parallel in hardware, not all instances may follow the same control flow path, and so a write may only occur for a subset of instances in a slot. Therefore in the naive scheme it would be necessary to track validity of each register element. However, if a block is 128 instances by 2 registers the number of validity bits required is 1008. Although resettable memory generally occupies a larger area than non-resettable memory, the resettable memory is only needed for the validity bits while the registers can remain as non-resettable memory which occupies less area, consumes less power and can achieve a lower latency than non-resettable memory.

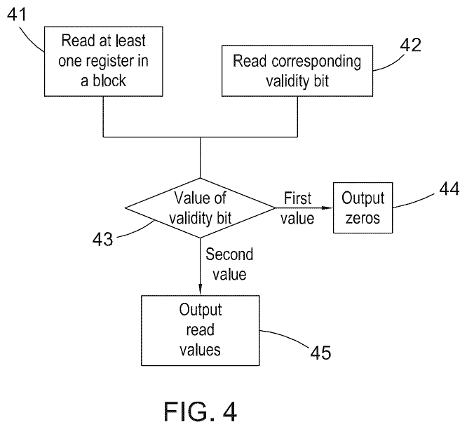

FIG. 4 depicts a method of reading data from a register memory according to the invention. At step 41 at least one of registers 20 in a block 25 is read. Often, a plurality, or all of, the registers (i.e. across both the ‘instance dimension’ and the ‘block width’ dimension) will be read in parallel. In parallel with this the validity bit corresponding to the block 25 is read 42. In this example steps 41 and 42 occur in parallel. However, they could equally be sequential with the validity bit being read after the register memory or before the register memory. In another example, reading the validity bit is part of the same reading step as reading the registers in a block. In this case (as in the case where the valid bit is stored separately but read in parallel to the data) there is no additional latency incurred by reading the valid bit as it occurs concurrently with reading the registers.

At step 43 the value of the validity bit is assessed. If the validity bit is a first value (e.g. 0), indicating that the data in the corresponding block is invalid then zeros are output. If the validity bit is a second value (e.g. 1), indicating that the data in the corresponding block is valid then the read data is output 45. Outputting zeros, rather than the values of the data, if the data is invalid prevents unauthorised access of the data. Thus, a subsequent program cannot access data written by a previous program. As an alternative to outputting zeros, any predetermined value can be output.

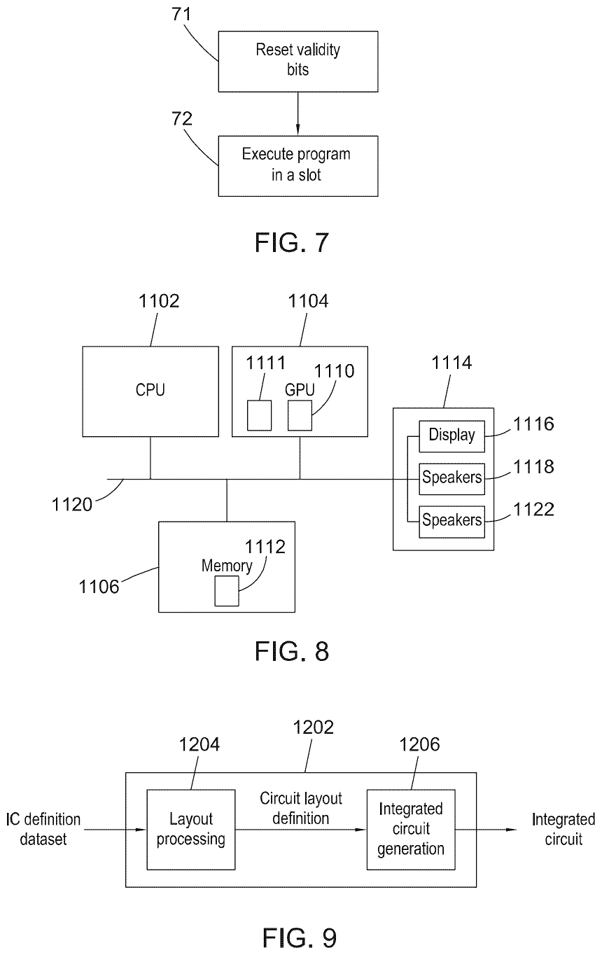

When the data stored in a block is no longer required (e.g. when all instances in the relevant Slot have finished executing the shader program) the corresponding validity bit can be reset to a first value to prevent any data being accessed. Validity data can be reset on a per block basis, allowing other slots to continue executing unaffected by the reset. Alternatively, validity bits corresponding to all blocks can be reset. As there are relatively few validity bits (compared to the size of the register as a whole) resetting the validity of all the registers (i.e. across both the ‘instance dimension’ and the ‘block width’ dimension) can be achieved quickly and generally within a single cycle. Most commonly resets (either for a subset of the memory or for the entire memory) will occur at the beginning or end of the execution of a program although it may occur at other times. FIG. 6 depicts the execution of a program in a slot (and noting that even if the same program may be executing in several slots, FIG. 6 would apply independently to each slot). The program is executed at step 61 and at step 62 the validity bits 30 of blocks 25 used by the program are reset to a first value. FIG. 7 depicts an alternative method of executing a program in which the validity bits 30 corresponding to the memory to be used by the program are reset to a first value 71 before the program is executed 72.

After the validity bits are reset then any read operation would, as described in FIG. 4, read the validity bit as a first value and thus output zeros (or another predetermined value). This would occur until the registers were written and the validity bit is set to a second value. Only then would a read operation read the data stored in the registers.

A GPU shader execution unit is a SIMD processor configured to process a number of instances of a task (i.e. the same program applied to different workloads, such as the same fragment shader being used to shade different fragments) in parallel. According to the invention the breadth of the block is equal to the number of instances the GPU shader execution unit can process in parallel.

A register file in the shader execution unit of a GPU has at least one read port and at least one write port and each port has a width, which is the number of registers it can read/write per instance (in parallel) across all instances in a slot. According to the invention, the block size is selected such that the width of the block matches the width of the smallest write port so that each block can always be fully written. For optimum efficiency the block has the dimensions of the smallest write port. As an example, if the smallest write port has dimensions of 128×2 (representing 2 registers for each of 128 instances) then the blocks 25 will be 128×2. Other write ports must have a width that is an integer multiple of the width of the block 25 (noting that the other dimension, being the number of instances, must be the same size for all write ports).

If a write port has a width three times the width of the block then all the registers of the three blocks will be written in parallel and the validity bits corresponding to each of the three blocks will also be set in parallel.

Write ports are configured such that they align with the block 25 i.e. it writes to one or more complete block(s) rather than part of one block and part of another block. If an instruction is received which does not align with the memory blocks it is split into two (or more) write operations: a first which writes to a complete first block and a second which writes to a complete second block. The registers which are not scheduled to be written with data are written with a predetermined value. Thus, write ports are configured such that either a complete block 25 is valid (i.e. every register can be read as it either contains data from the current program or dummy data) or nothing is valid: the validity bit corresponds to the entire block. Accordingly, it is not possible to validate just part of a block.

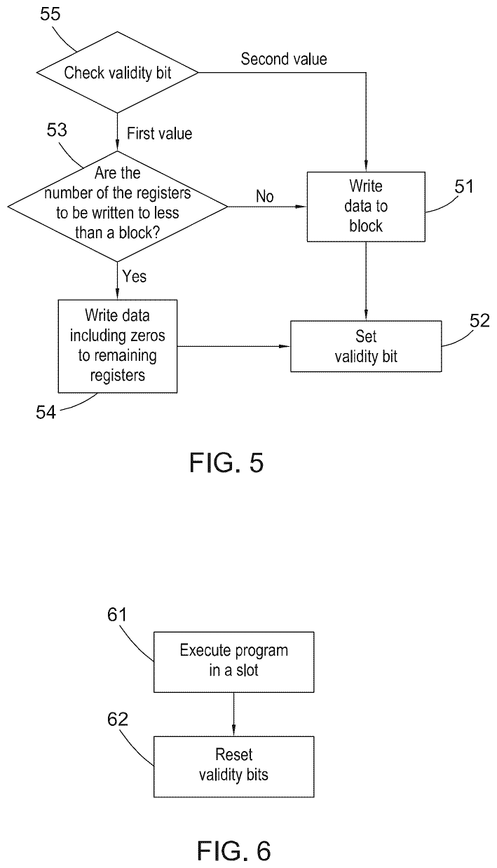

FIG. 5 depicts a method of writing data to a memory according to the invention. As described above, every register in a block (i.e. across both the ‘instance dimension’ and the ‘block width’ dimension) must be completely valid or completely invalid. According to this example, the validity bit is initially checked 55. If the validity bit is a second value (indicating valid data) the data is written to the registers. If the validity bit is a first value (indicating that the registers do not contain valid data), whether the number of registers to be written to (in other words, the quantity of data) is less than a block 25 is determined at step 53. The number of registers to be written to may be less than all the registers in the block either because each instance does not require the full width of registers available in the block and/or because the write operation relates to fewer than the total number of instances spanned by block (because one or more instances are not utilised, and/or because not all the instances need to write data as part of that write operation). If the number of registers to be written is not less than the number of registers in the block, then the data is written 51 to the block 25. If it is less than the number of registers then the data is written 54 including zeros (or another predetermined value) to each of the remaining registers. As mentioned above, those remaining registers may be additional registers in the block width dimension that are not required by the instances for which data is being written and/or the registers relating to instances for which no data needs to be written. In both cases, step 54 involves expanding the write instruction. That is, the write instruction is expanded to cover the whole block width if does not already cover the whole width, and/or the write instruction is expanded to cover all instances in the block if it does not already cover all instances in the block. Finally the validity bit is set 52. If the validity bit 30 is a second value (indicating that the data is valid) the remaining registers are not written with zeros because the data within the registers is already valid, and so there is no need to perform the equivalent of step 53 to assess the number of registers being written nor is there any need expand the write operation (in either dimension). Instead only the instructed data is written 51 to the block 25. Similarly, whilst FIG. 5 indicates that after writing the data at step 51 the validity bit is set 52, in the scenario when the validity bit is already set (i.e. when it is determined to have the second value at step 55) it is not necessary to set the validity bit again. Setting the validity bit again is not technically problematic but, in the scenario that the validity bit already has the second value, the step may be omitted because that is more efficient.

Read ports may be smaller than the size of a block 25. If a read port is smaller the same method as depicted in FIG. 4 is used: one or more of the registers is read and the corresponding validity bit (which is equally valid for a subset of the registers) is checked. Alternatively, a read port could be larger than a block 25. In this situation one or more registers from a plurality of blocks are read in parallel and the validity bits corresponding to the blocks are read. For each block, the value of the data is output if the corresponding validity bit is a second value and zeros (or another predetermined value) is output if the corresponding validity bit is a first value. Accordingly, within a single read operation by a larger read port, some data values may be output (where the validity bit indicates the data is valid) and some zeros (where the validity bit indicates the data is invalid) may be output. In larger read ports the reading the different blocks occurs in parallel, the reading of the validity bits occurs in parallel, and the outputting of values or zeros occurs in parallel.

FIG. 8 shows a computer system in which the graphics processing systems described herein may be implemented. The computer system comprises a CPU 1102, a GPU 1104, a memory 1106, a neural network accelerator (NNA) 1108 and other devices 1114, such as a display 1116, speakers 1118 and a camera 1122. Processing blocks 1110 and 1111 (corresponding to processing blocks 104 and 106) are implemented on the GPU 1104. In other examples, one or more of the depicted components may be omitted from the system, and/or the processing block 1110 may be implemented on the CPU 1102 or within the NNA 1108. The components of the computer system can communicate with each other via a communications bus 1120. A store 1112 (corresponding to memory 102) is implemented as part of the memory 1106.

The graphics processing system of FIG. 1 is shown as comprising a number of functional blocks. This is schematic only and is not intended to define a strict division between different logic elements of such entities. Each functional block may be provided in any suitable manner. It is to be understood that intermediate values described herein as being formed by a graphics processing system need not be physically generated by the graphics processing system at any point and may merely represent logical values which conveniently describe the processing performed by the graphics processing system between its input and output.

The graphics processing systems described herein may be embodied in hardware on an integrated circuit. The graphics processing systems described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a graphics processing system configured to perform any of the methods described herein, or to manufacture a graphics processing system comprising any apparatus described herein. An integrated circuit definition dataset may be, for example, an integrated circuit description.

Therefore, there may be provided a method of manufacturing, at an integrated circuit manufacturing system, a graphics processing system as described herein. Furthermore, there may be provided an integrated circuit definition dataset that, when processed in an integrated circuit manufacturing system, causes the method of manufacturing a graphics processing system to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a graphics processing system will now be described with respect to FIG. 7.

FIG. 9 shows an example of an integrated circuit (IC) manufacturing system 1202 which is configured to manufacture a graphics processing system as described in any of the examples herein. In particular, the IC manufacturing system 1202 comprises a layout processing system 1204 and an integrated circuit generation system 1206. The IC manufacturing system 1202 is configured to receive an IC definition dataset (e.g. defining a graphics processing system as described in any of the examples herein), process the IC definition dataset, and generate an IC according to the IC definition dataset (e.g. which embodies a graphics processing system as described in any of the examples herein). The processing of the IC definition dataset configures the IC manufacturing system 1202 to manufacture an integrated circuit embodying a graphics processing system as described in any of the examples herein.

The layout processing system 1204 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimise the circuit layout. When the layout processing system 1204 has determined the circuit layout it may output a circuit layout definition to the IC generation system 1206. A circuit layout definition may be, for example, a circuit layout description.

The IC generation system 1206 generates an IC according to the circuit layout definition, as is known in the art. For example, the IC generation system 1206 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1206 may be in the form of computer-readable code which the IC generation system 1206 can use to form a suitable mask for use in generating an IC.

The different processes performed by the IC manufacturing system 1202 may be implemented all in one location, e.g. by one party. Alternatively, the IC manufacturing system 1202 may be a distributed system such that some of the processes may be performed at different locations, and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a graphics processing system without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 9 by an integrated circuit manufacturing definition dataset may cause a device as described herein to be manufactured.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

What is claimed is:

1. A method of writing data to a register file, the register file having a plurality of registers and a plurality of validity bits, the plurality of registers being divided into a plurality of blocks, a block corresponding to one or more instances and a subset of the registers being allocated to each of those instances, each block having a corresponding validity bit, the register file having at least one write port, wherein the width of each block matches the width of a smallest write port of the at least one write ports, the method comprising:
reading the validity bit corresponding to the first block;
writing data to one or more registers in a first block;
if the validity bit is equal to a first value and if the quantity of data to be written is less than the number of registers in the first block, writing a predetermined value to the remaining registers in the first block; and
setting the validity bit corresponding to the first block of registers to a second value.

2. The method according to claim 1, wherein each of the write ports has a width which is an integer multiple of the of the block width.

3. The method according to claim 1, wherein the validity bit is set in parallel to the writing to the one or more registers in the block.

4. The method according to claim 1, further comprising:
writing data to each register in a second block in parallel with writing to the first block;
setting, in parallel with setting the validity bit corresponding to the first block of registers, the validity bit corresponding to the second block of registers to a second value.

5. The method according to claim 1, wherein writing a predetermined value to the remaining registers in the first block comprises expanding the write to cover all instances in the block and/or expanding the write to cover the entire subset of registers allocated to each of the instances.

6. The method according to claim 1, wherein the method is carried out by a GPU.

7. The method according to claim 6, the GPU being a single instruction multiple data processor configured to process a number of elements in parallel and wherein the block has a breadth equal to the number of elements the GPU can process in parallel.

8. The method according to claim 7, the GPU having one or more write functions configured to write to a plurality of registers and wherein the block has a width no greater than the width of the write function configured to write to the fewest registers.

9. The method according to claim 8, wherein each write function is configured to write to an integer multiple of the size of the block.

10. The method according to claim 1, further comprising setting at least one of the validity bits to the first value.

11. The method according to claim 10, further comprising setting all the validity bits to the first value.

12. The method according to claim 1, wherein the register files are non-resettable memory.

13. The method according to claim 1, wherein the validity bits are resettable memory.

14. A register file having a plurality of registers and a plurality of validity bits, the plurality of registers being divided into a plurality of blocks, a block corresponding to one or more instances and a subset of the registers being allocated to each of those instances, each block having a corresponding validity bit, the register file having at least one write port, wherein the width of each block matches the width of a smallest write port of the at least one write ports.

15. The register file according to claim 14, wherein each of the write ports has a width which is an integer multiple of the of the block width.

16. A graphics processing system configured to perform the method as set forth in claim 1.

17. The graphics processing system of claim 16, wherein the graphics processing system is embodied in hardware on an integrated circuit.

18. A non-transitory computer readable storage medium having stored thereon computer code that when run causes the method as set forth in claim 1 to be performed.

19. A non-transitory computer readable storage medium having stored thereon an integrated circuit definition dataset that when inputted into an integrated circuit manufacturing system causes the integrated circuit manufacturing system to manufacture a graphics processing system as set forth in claim 17,
